(19) United States
(12) Patent Application Publication
(10) Pub. No.: US 2006/0162993 A1
(43) Pub. Date: Jul. 27, 2006

(54) Suspension and electro-acoustic transducer using the suspension

(75) Inventors: Kazuki Honda, Mie (JP); Koji Sano, Mie (JP); Tatsuya Omori, Uji-shi (JP)

Correspondence Address: WENDEROTH, LIND & PONACK, L.L.P., 2033 K STREET N. W., SUITE 800, WASHINGTON, DC, 20006-1021, US

(73) Assignee: MATSUSHITA ELECTRIC INDUSTRIAL CO., LTD, OSADKA 571-8501 (JP)

(21) Appl. No.: 10/523,694

(22) PCT Filed: Oct. 2, 2003
(86) PCT No.: PCT/JP03/12644

§ 371 Date: Feb. 3, 2005

(30) Foreign Application Priority Data
Oct. 25, 2002 (JP) 2002-310771

(51) Int. Cl. H04R 7/00

(52) U.S. Cl. 181/172; 181/173

(57) ABSTRACT

A suspension (1a) includes a plurality of roll sections (1b) each of which has a semicylindrical shape in a cross section. The roll sections (1b) are disposed side by side based on a straight line connecting two points on an inner periphery or an outer periphery. The roll sections (1b) form a closed loop in a manner that a roll section (1b) of the roll sections (1b) being disposed first adjoins a roll section (1b) of the roll sections (1b) being disposed last. Adjacent roll sections (1b) are coupled with each other through a boundary section (2) forming a continuous three dimensional curved surface. A linearity of compliance improves, and generation of distortion or rolling is restricted using the suspension (1a).

### TECHNICAL FIELD

The present invention relates to a suspension used in an apparatus for reproducing a sound such as a voice, music or a dial tone, and an electro-acoustic transducer using the same.

### BACKGROUND ART

A conventional electro-acoustic transducer is demonstrated hereinafter with reference to FIGS. 8, 9A and 9B. FIG. 8 is a sectional view of the electro-acoustic transducer. FIG. 9A is a plan view of a diaphragm. FIG. 9B is a sectional view of FIG. 9A taken along the line 9B-9B. In FIG. 8, diaphragm 6 generates aerial vibration. Diaphragm 6 is fixed to frame 11 by frame fixing part 4 through suspension 1 which has vibrating functions and supporting functions. Suspension 1 is of a semicylindrical shape in a cross section and uniform in a circumference direction. Diaphragm 6 is coupled with voice coil 10. Voice coil 10 is placed within magnetic gap 9 of magnetic circuit 8 which is provided at the middle of the frame 11 and formed of plate 13, magnet 14 and yoke 15.

Furthermore, protector 12 for protecting diaphragm 6 is bonded by using an adhesive. An operation of an electromotive loudspeaker structured mentioned above is described hereinafter.

When a current flows in voice coil 10, the current crosses a magnetic field in magnetic gap 9 at right angles, and driving force generated at voice coil 10 is ATTACHMENT B transmitted to diaphragm 6. Then suspension 1 supports voice coil 10 in a manner that voice coil 10 becomes concentric with plate 13, and works as a spring in a vibrating direction when diaphragm 6 vibrates. When an alternating current (e.g., a voice signal) flows in voice coil 10, voice coil 10 and diaphragm 6 vibrate while being supported by suspension 1. As a result, air vibrates and a compressional wave is generated, so that a sound can be heard. For example, Japanese Patent Unexamined Publication H5-103395 is known as a related art of this invention.

However, the conventional suspension has a uniform disk shape in a circumference direction and a closed structure. Therefore, as shown in an arbitrary point P of FIG. 5, which is a sectional view of the suspension in vibration and demonstrated later, when the suspension vibrates by ΔX, a radius of point P changes by Δr, so that force is generated in a circumference direction.

This force is easy to be generated according as the suspension vibrates at large amplitude. As shown in line “A” of FIG. 4, which is a force-displacement characteristic and demonstrated later, compliance becomes non-linear at the large amplitude. Non-linearity of the compliance of supporting force, which is caused by a shape of suspension 1, causes distortion particularly in reproduction of a low tone area where amplitude becomes large.

Compliance of the suspension becomes difficult to be maintained due to these phenomena, so that harmonic distortion is generated at sound pressure frequency characteristics. In addition, a deformation of the suspension is also induced, thereby causing a rolling phenomenon of the diaphragm.

### SUMMARY OF THE INVENTION

A suspension includes a plurality of roll sections each of which has a semicylindrical shape in a cross section. The roll sections are disposed side by side based on a straight line connecting two points on an inner periphery or an outer periphery. The roll sections form a closed loop in a manner that a roll section of the roll sections being disposed first adjoins a roll section of the roll sections being disposed last. Adjacent roll sections are coupled with each other through a boundary section forming a continuous three dimensional curved surface.

### BRIEF DESCRIPTION OF THE DRAWINGS

FIG. 1A is a plan view of a suspension in accordance with a first exemplary embodiment of the present invention.

FIG. 1B is a sectional view of the suspension of FIG. 1A taken along the line 1B-1B in accordance with the first exemplary embodiment of the present invention.

FIG. 2A is a perspective view of the suspension in accordance with the first exemplary embodiment of the present invention.

FIG. 2B is an enlarged sectional view of the suspension of FIG. 2A taken along the line 2B-2B in accordance with the first exemplary embodiment of the present invention.

FIG. 2C is an enlarged sectional view of the suspension of FIG. 2A taken along the line 2C-2C in accordance with the first exemplary embodiment of the present invention.

FIG. 3 is a sectional view of an electro-acoustic transducer using the suspension in accordance with the first exemplary embodiment of the present invention.

FIG. 4 is a graph showing a force-displacement characteristic of the suspension in vibration in accordance with the first exemplary embodiment of the present invention.

FIG. 5 shows a condition of the suspension in vibration in accordance with the first exemplary embodiment of the present invention.

FIG. 6A is a plan view of a suspension device in accordance with a second exemplary embodiment of the present invention.

FIG. 6B is a sectional view of the suspension device of FIG. 6A taken along the line 6B-6B in accordance with the second exemplary embodiment of the present invention.

FIG. 7A is a plan view of a suspension device in accordance with a third exemplary embodiment of the present invention.

FIG. 7B is a sectional view of the suspension device of FIG. 7A taken along the line 7B-7B in accordance with the third exemplary embodiment of the present invention.

FIG. 8 is a sectional view of a conventional electro-acoustic transducer.

FIG. 9A is a plan view of a suspension which is an essential part of the conventional electro-acoustic transducer.

FIG. 9B is a sectional view of the suspension of the conventional electro-acoustic transducer of FIG. 9A taken along the line 9B-9B.

### DETAILED DESCRIPTION OF PREFERRED EMBODIMENTS

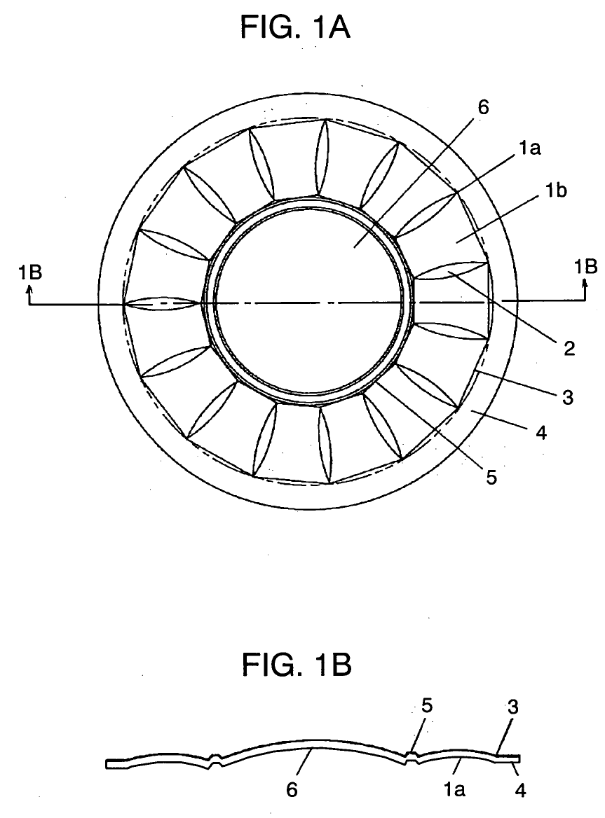

Exemplary embodiments of suspensions of the present invention are demonstrated hereinafter with reference to FIG. 1 through FIG. 7B. In the description, the same elements used in the background art have the same reference marks, and the descriptions of those elements are omitted here.

### First Exemplary Embodiment

The first exemplary embodiment of the present invention is demonstrated hereinafter with reference to FIG. 1 through FIG. 5.

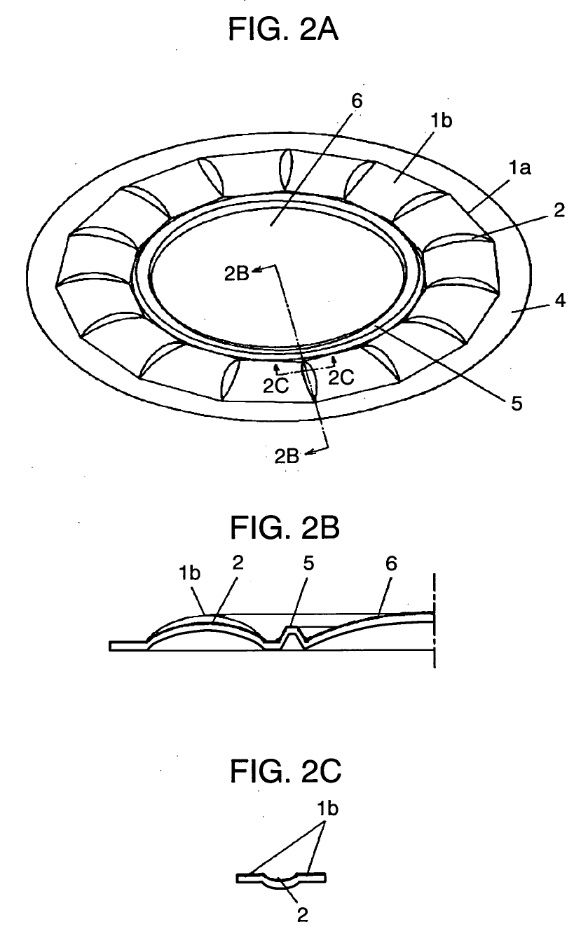

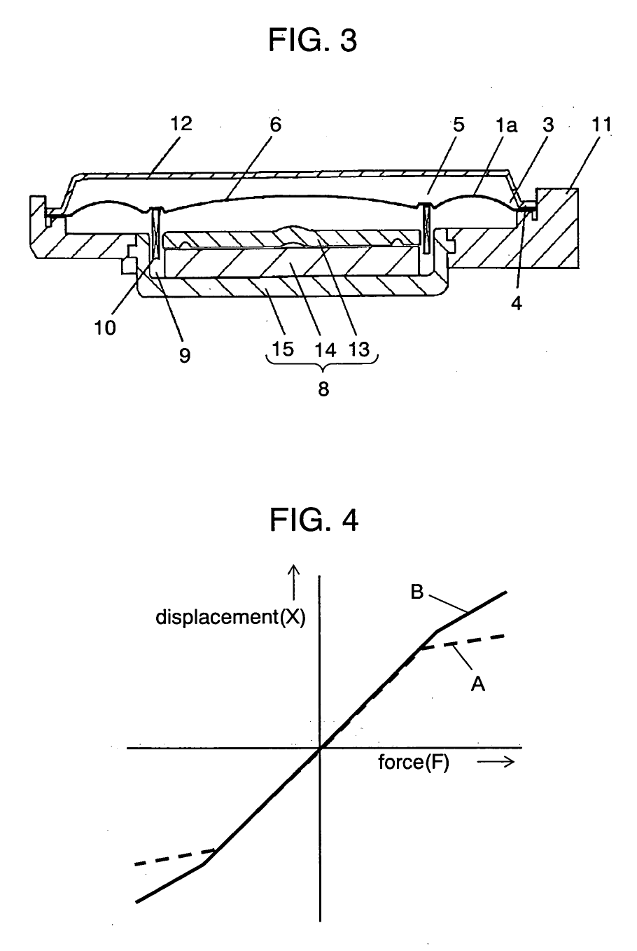

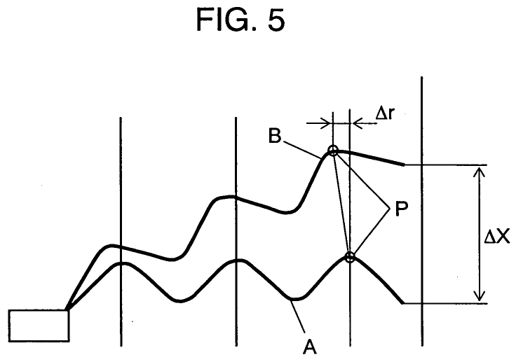

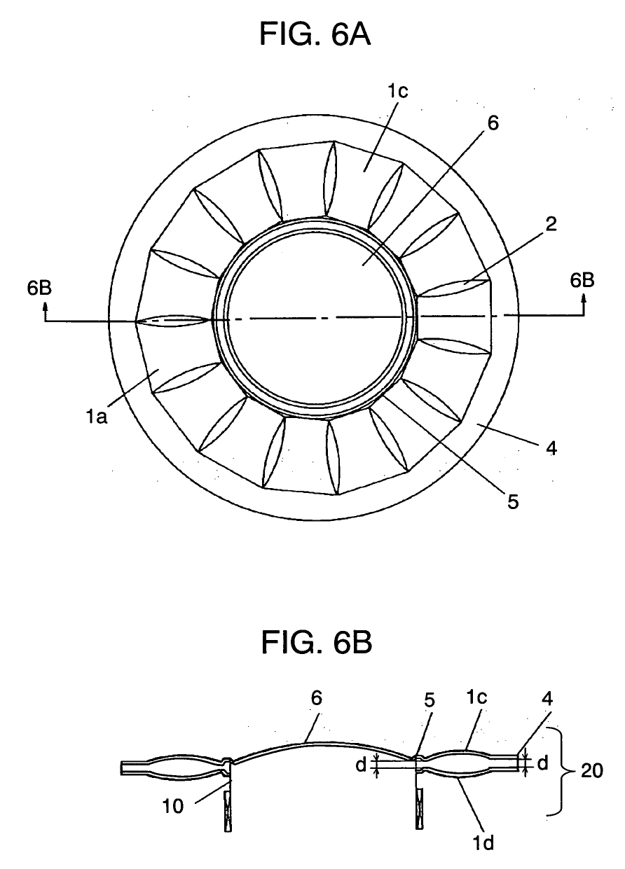

FIG. 1A is a plan view of a suspension in accordance with the first exemplary embodiment of the present invention. FIG. 1B is a sectional view of FIG. 1A taken along the line 1B-1B. FIG. 2A is a perspective view of FIG. 1A. FIG. 2B is an enlarged sectional view of FIG. 2A taken along the line 2B-2B. FIG. 2C is an enlarged sectional view of FIG. 2A taken along the line 2C-2C. FIG. 3 is a sectional view of an electro-acoustic transducer using the suspension. FIG. 4 is a graph showing a force-displacement characteristic of the suspension in vibration. FIG. 5 shows a condition of the suspension in vibration.

In FIGS. 1A and 1B, roll sections 1b are disposed radially at a periphery of diaphragm 6 so as to form suspension 1a. Connecting part 3 between frame fixing part 4 and vibration system fixing part 5 is formed linear. Adjacent roll sections 1b are coupled with each other through boundary section 2 which forms a continuous three dimensional curved surface. Non-continuous parts of connecting parts 3 between frame fixing part 4 and vibration system fixing part 5 are trimmed, so that connecting parts 3 forms a closed loop. Because a plane of vibration is structured as a circle, an ellipse, or a polygon such as a quadrilateral or a rectangle in its plan view, roll section 1b is not limited in size or arrangement.

When each roll section 1b has the same shape, roll sections 1b are disposed at regular intervals, thereby forming a closed loop. Adjacent roll sections 1b are coupled with each other through boundary section 2 which forms a continuous three dimensional curved surface. Non-continuous parts of connecting parts 3 between frame fixing part 4 and vibration system fixing part 5 are trimmed, so that connecting parts 3 form a closed loop. An outer periphery part of suspension 1a is fixed to frame 11 by frame fixing part 4, and an inner periphery part thereof is fixed to diaphragm 6 or voice coil 10 by vibration system fixing part 5.

Because connecting part 3 of roll section 1b is formed linear, force caused by generation of Δr in FIG. 5 is not generated in lateral direction. Because of deformation of a semicylindrical shape of roll section 1b in vibration, boundary section 2 accommodates stress generated at a boundary between adjacent roll sections 1b. Therefore, as shown in “B” at large amplitude of the force-displacement characteristic of FIG. 4, a superior linearity of compliance can be obtained even at large amplitude, so that unnecessary resonance can be -restricted. In addition, boundary section 2 covers a gap between roll sections 1b, so that dust can be prevented at magnetic gap 9.

Besides, a sectional shape of boundary section 2 between roll sections 1b is not limited to a semicylindrical shape shown in FIG. 2C.

The outer periphery part of the suspension is fixed to the roll sections forming a closed loop, and non-continuous parts are trimmed, so that the suspension is formed. Connection between the roll sections and the inner periphery part is trimmed, so that generation of distortion or the like is prevented.

In addition, frame fixing part 4, which is a connecting part between an outer linear portion of roll section 1b and frame 11, is trimmed to be formed as a continuous shape and fixed to frame 11.

Furthermore, vibration system fixing part 5, which is a connecting part between an inner linear portion of roll section 1b and diaphragm 6, is trimmed to be formed as a continuous shape and fixed to diaphragm 6 or voice coil 10.

According to the first exemplary embodiment, an odd number of roll sections 1b are described. Because the roll sections disposed at a periphery are formed asymmetric, generation of rolling in driving is prevented when the suspension is mounted in an electro-acoustic transducer.

Using the structure discussed above, amplitude becomes stable, so that deformation, which causes the rolling phenomenon, of suspension 1a can be prevented. As a result, distortion which affects acoustic characteristics can be reduced.

In addition, suspension 1a may be formed by heat-molding of a polymer resin film or thermoplastic elastomer film, or formed by injection-molding of resin. Using the method mentioned above, a complicated shape is easy to be formed, and suspension 1a can be integrally molded with diaphragm 6, so that the number of manufacturing processes can decrease.

Furthermore, suspension 1a may be formed by weaving vegetable fiber and/or chemical fiber, impregnating resin and press-molding. In addition, suspension 1a may be formed by heat-molding a sliced sheet of polyurethane form which is obtained after chemical reaction of mixing of isocyanate and polyol. Besides, suspension 1a may be formed by vulcanizing unvulcanized compositions such as NBR, SBR or EPDM, which are pliable material, using heat press. Using suspension 1a discussed above, deformation can be prevented and a linearity of compliance can be obtained.

According to the first embodiment, suspension 1a is coupled with diaphragm 6, however, suspension 1a may be fixed to voice coil 10.

Furthermore, according to the first embodiment, roll section 1b is formed based on a straight line connecting two points on an outer periphery, however, roll section 1b may be formed based on a straight line connecting two points on an inner periphery.

### Second Exemplary Embodiment

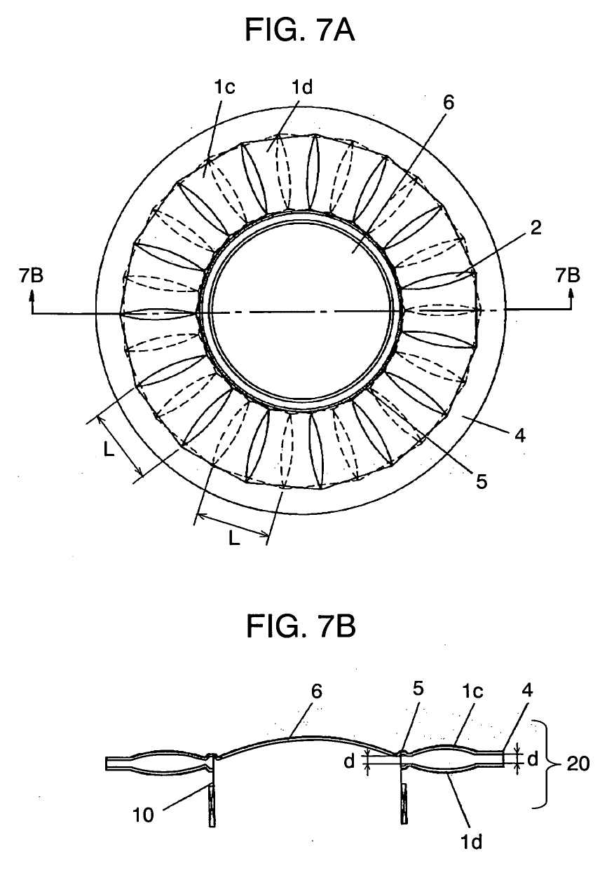

The second exemplary embodiment of suspension device 20 of the present invention is demonstrated hereinafter with reference to FIGS. 6A and 6B.

FIG. 6A is a plan view of suspension device 20 in accordance with the second exemplary embodiment of the present invention. FIG. 6B is a sectional view of FIG. 6A taken along the line 6B-6B.

Only different point between the first embodiment and the second embodiment is described hereinafter with reference to FIGS. 6A and 6B. Suspensions 1c and 1d each have the same shape as suspension 1a, and are fixed to voice coil 10. Suspension 1c is placed above suspension 1d at a certain distance. Suspension device 20 has suspensions 1c and 1d. Suspension 1c may be fixed to or integrally molded with diaphragm 6.

### Third Exemplary Embodiment

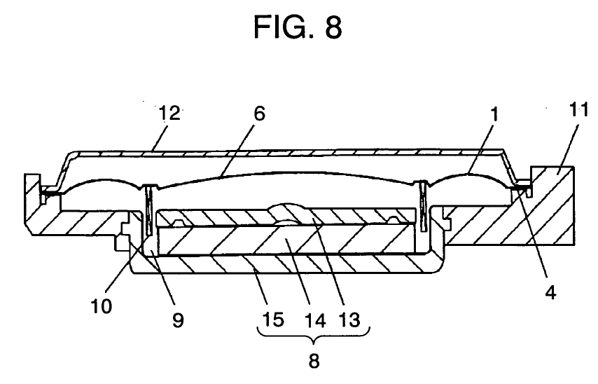

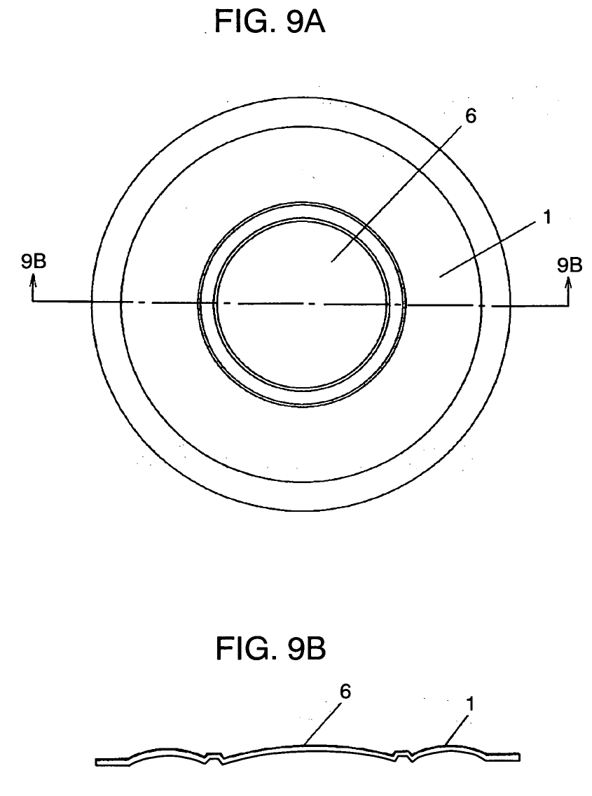

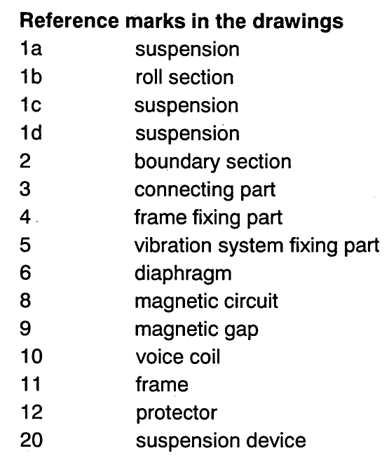

The third exemplary embodiment of suspension device 20 of the present invention is demonstrated hereinafter with reference to FIGS. 7A and 7B.

FIG. 7A is a plan view of suspension device 20 in accordance with the third exemplary embodiment of the present invention. FIG. 7B is a sectional view of FIG. 7A taken along the line 7B-7B. Suspension device 20 has suspensions 1c and 1d. Suspensions 1c and 1d each have the same shape as suspension 1a, and suspension 1c is shifted from suspension 1d by approximately ½ of width “L” of the roll section in a rotating direction (i.e., a periphery direction).

In other words, suspensions 1c and 1d are disposed in a substantially vertical direction, and one of suspensions 1c and 1d is rotated by ½ of a width of the roll section with respect to an axis in the periphery direction. Generation of rolling in driving can be prevented when the suspension is mounted in an electro-acoustic transducer.

Suspensions 1c and 1d are fixed to voice coil 10 and spaced each other. Suspension 1c may have the same direction as suspension 1d or have a reverse direction of suspension 1d. Using the structure discussed above, rigidity of suspension device 20 increases and rolling is further prevented.

According to the second and third embodiments, upper suspension 1c is fixed to the diaphragm, however, suspension 1c may be coupled with voice coil 10.

In addition, rolling is further prevented by widening interval “d” between suspensions 1c and 1d.

### INDUSTRIAL APPLICABILITY

The present invention provides a suspension where stress generated at its inside in a circumference direction is individually divided. Using this structure, a superior linearity of compliance can be obtained, distortion which affects acoustic characteristics can be reduced and rolling caused by deformation can be restricted. As a result, the suspension which is suitable for large amplitude and has supporting functions can be obtained. Therefore, an electro-acoustic transducer which can expand low-tone-reproducing bands by reducing a minimum resonance frequency is provided, even when it is structured with the same width as a conventional one.

1. A suspension comprising:
a plurality of roll sections each of which has a semicylindrical shape in a cross section,
wherein the roll sections are disposed side by side based on a straight line connecting two points on an inner periphery or an outer periphery,
wherein the roll sections form a closed loop in a manner that a roll section of the roll sections being disposed first adjoins a roll section of the roll sections being disposed last,
wherein adjacent roll sections are coupled with each other through a boundary section forming a continuous three dimensional curved surface.

2. A suspension comprising:
a plurality of roll sections each of which has a semicylindrical shape in a cross section,
wherein the roll sections are disposed radially side by side at regular intervals based on a straight line connecting two points on an inner periphery or an outer periphery,
wherein the roll sections form a closed loop in a manner that a roll section of the roll sections being disposed first adjoins a roll section of the roll sections being disposed last,
wherein adjacent roll sections are coupled with each other through a boundary section forming a continuous three dimensional curved surface.

3. The suspension of claim 1,
wherein the inner periphery is coupled with the roll sections forming the closed loop, and non-continuous parts of the inner periphery are trimmed,
wherein the outer periphery has a frame fixing part for being fixed at a frame.

4. The suspension of claim 1,
wherein the outer periphery is coupled with the roll sections forming the closed loop, and non-continuous parts of the outer periphery are trimmed,
wherein the inner periphery has a vibration system fixing part for fixing a diaphragm or a voice coil.

5. The suspension of claim 1,
wherein an odd number of the roll sections are disposed.

6. A suspension device comprising:
two suspensions of claim 1 being disposed in a substantially vertical direction.

7. A suspension device comprising:
two suspensions of claim 1 being disposed in a substantially vertical direction,
wherein one of the suspensions is rotated by ½ of a width of the roll section with respect to an axis in a periphery direction.

8. An electro-acoustic transducer comprising:
a suspension of claim 1,
wherein the inner periphery is coupled with a voice coil placed in a magnetic gap of a magnetic circuit or an outer periphery part of a diaphragm coupled with the voice coil,
wherein the outer periphery is fixed to a frame which supports the magnetic circuit and a vibration system.

9. The suspension of claim 2,
wherein the inner periphery is coupled with the roll sections forming the closed loop, and non-continuous parts of the inner periphery are trimmed,
wherein the outer periphery has a frame fixing part for being fixed at a frame.

10. The suspension of claim 2,
wherein the outer periphery is coupled with the roll sections forming the closed loop, and non-continuous parts of the outer periphery are trimmed,
wherein the inner periphery has a vibration system fixing part for fixing a diaphragm or a voice coil.

11. The suspension of claim 2,
wherein an odd number of the roll sections are disposed.

12. A suspension device comprising:
two suspensions of claim 2 being disposed in a substantially vertical direction.

13. A suspension device comprising:
two suspensions of claim 2 being disposed in a substantially vertical direction, wherein one of the suspensions is rotated by ½ of a width of the roll section with respect to an axis in a periphery direction.

14. An electro-acoustic transducer comprising:
a suspension of claim 2,
wherein the inner periphery is coupled with a voice coil placed in a magnetic gap of a magnetic circuit or an outer periphery part of a diaphragm coupled with the voice coil,
wherein the outer periphery is fixed to a frame which supports the magnetic circuit and a vibration system.
